(19) United States
(12) Patent Application Publication
(10) Pub. No.: US 2026/0188153 A1
(43) Pub. Date: Jul. 2, 2026

(54) μLED DRIVING CIRCUIT AND TEST METHOD THEREOF

(71) Applicant: AUO Corporation, Hsinchu City (TW)

(72) Inventors: Yueh-Hung CHUNG, Hsinchu City (TW); Sheng-Yen CHENG, Hsinchu City (TW); Ya-Ling HSU, Hsinchu City (TW); Chen-Hsien LIAO, Hsinchu City (TW)

(21) Appl. No.: 19/264,896

(22) Filed: Jul. 10, 2025

(30) Foreign Application Priority Data
Dec. 27, 2024 (TW) 113151227

(51) Int. Cl. G09G 3/00; G09G 3/32

(52) U.S. Cl. CPC G09G 3/006; G09G 3/32; G09G 2320/0271; G09G 2330/12

(57) ABSTRACT

The application discloses a micro light-emitting diode (μLED) driving circuit and a test method thereof. In response to completion of fabrication of a first predetermined metal layer, a first test path is formed. The first test path passes through a driving circuit and a first test transistor of a test circuit, for testing at least one first defect existing prior to fabrication of the first predetermined metal layer. In response to completion of fabrication of a second predetermined metal layer, a second test path is formed. The second test path passes through the driving circuit and a second test transistor of the test circuit, for detecting at least one second defect occurring after the fabrication of the first predetermined metal layer.

This application claims the benefit of Taiwan application Serial No. 113151227, filed Dec. 27, 2024, the disclosure of which is incorporated by reference herein in its entirety.

### TECHNICAL FIELD

The disclosure relates to a micro-LED (light emitting diode) (μLED) driving circuit and a test method thereof.

### BACKGROUND

Micro-LED (μLED) is increasingly gaining attention and its applications are becoming more widespread. μLED is an emerging display technology with a wide range of use cases, including but not limited to the following. Consumer electronics applications of μLED include: (1) Smartwatches and wearable devices: High brightness and low power consumption making it suitable for small screen applications; (2) Smartphones: Enabling high resolution and excellent color performance. Large display applications of μLED include: (1) Outdoor and indoor display walls: High brightness and long lifespan making it suitable for various public display purposes; (2) Commercial applications: Providing high-quality visual effects in fields such as retail and billboards. Automotive and aviation applications of μLED include: (1) In-vehicle displays: Offering better visibility and durability; (2) In-flight entertainment systems: Durable, energy-efficient, and clear visuals. AR/VR equipment applications of μLED include: the high brightness and compact size of μLED making it suitable for near-eye displays (such as AR glasses and VR headsets). Medical equipment applications of μLED include: when used in high-resolution small displays, μLED can be applied to endoscopes, microscopes, and other medical instruments. Lighting and special purpose applications of μLED includes: μLED can be used in precision light sources, optical communication, or special wavelength applications such as ultraviolet or infrared lighting.

The advantages of μLED include high brightness and high contrast, making it suitable for outdoor or high-light environments. Each pixel can emit light independently, providing excellent contrast. Additionally, μLED features low power consumption—more energy-efficient than OLED and traditional LCD, especially when displaying high-brightness images due to its high luminous efficiency. Further advantages of μLED include long lifespan and durability. Compared to OLED (organic light-emitting diodes), μLED is less prone to burn-in issues and has a longer lifespan, making it suitable for extreme environments. μLED also has an ultra-fast response time, ideal for high-refresh-rate applications such as AR/VR devices. μLED delivers excellent color performance. Thanks to its RGB pixel design, it achieves a wide color gamut and precise color representation. The pixel pitch of μLED can be extremely small, supporting ultra-high resolution and miniaturized designs, which are especially suitable for micro-displays and near-eye applications. μLED displays can be modularly designed for seamless large-screen splicing.

Current testing methods may still be insufficient for effectively detecting μLED defects.

Therefore, this invention provides a μLED driving circuit and its testing method to improve upon the shortcomings of existing testing approaches.

### SUMMARY

According to one embodiment, a method for testing a micro light-emitting diode (μLED) driving circuit is provided. The method comprises: in response to completion of fabrication of a first predetermined metal layer, forming a first test path, the first test path passing through a driving circuit and a first test transistor of a test circuit, for testing at least one first defect existing prior to fabrication of the first predetermined metal layer; and in response to completion of fabrication of a second predetermined metal layer, forming a second test path, the second test path passing through the driving circuit and a second test transistor of the test circuit, for detecting at least one second defect occurring after the fabrication of the first predetermined metal layer.

According to another embodiment, a micro light-emitting diode (μLED) driving circuit is provided. The micro light-emitting diode (μLED) driving circuit comprises: a grayscale control circuit; a driving circuit coupled to the grayscale control circuit; a test circuit coupled to the driving circuit, the test circuit including a first test transistor and a second test transistor; wherein in response to completion of fabrication of a first predetermined metal layer, forming a first test path, the first test path passing through the driving circuit and the first test transistor of the test circuit, for testing at least one first defect existing prior to fabrication of the first predetermined metal layer; and in response to completion of fabrication of a second predetermined metal layer, forming a second test path, the second test path passing through the driving circuit and the second test transistor of the test circuit, for detecting at least one second defect occurring after the fabrication of the first predetermined metal layer.

### BRIEF DESCRIPTION OF THE DRAWINGS

FIG. 1 illustrates a circuit diagram of a μLED driving circuit according to an embodiment of the present disclosure.

FIG. 2 illustrates a circuit diagram of a μLED driving circuit according to another embodiment of the present disclosure.

FIG. 3 illustrates a circuit diagram of a μLED driving circuit according to another embodiment of the present disclosure.

FIG. 4 illustrates a circuit diagram of a μLED driving circuit according to another embodiment of the present disclosure.

FIG. 5 illustrates a circuit diagram of a μLED driving circuit according to another embodiment of the present disclosure.

FIG. 6 illustrates a circuit diagram of a μLED driving circuit according to another embodiment of the present disclosure.

FIG. 7A illustrates a circuit diagram of a μLED driving circuit according to an embodiment of the present disclosure.

FIG. 7B shows a partial cross-sectional view of the μLED driving circuit depicted in FIG. 7A.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

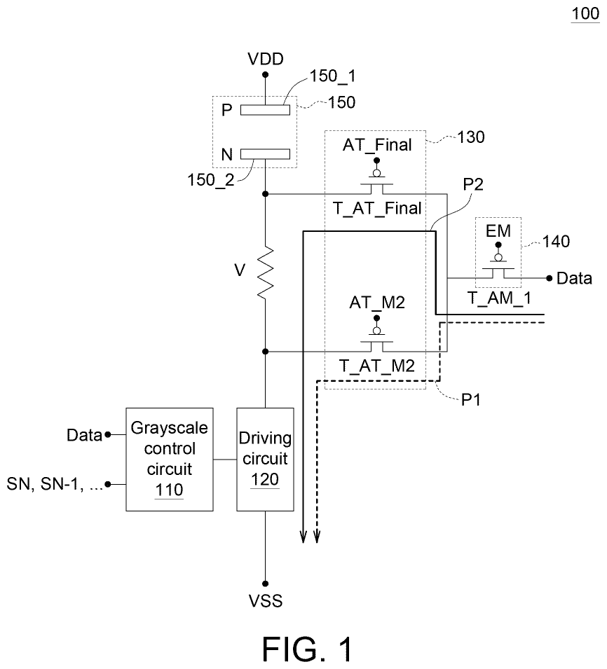

FIG. 1 illustrates a circuit diagram of a μLED driving circuit according to an embodiment of the present disclosure. The μLED driving circuit 100 comprises: a grayscale control circuit 110, a driving circuit 120, a testing circuit 130, a light emission control circuit 140, and a bonding area 150. The bonding area 150 is configured to be bonded to a μLED. In addition, the bonding area 150 includes pads 150_1 and 150_2.

The grayscale control circuit 110 is configured to control the grayscale level based on a data signal (Data) and gate driving signals SN, SN-1, etc.

The driving circuit 120 is coupled to the grayscale control circuit 110 and configured to drive the μLED.

The testing circuit 130 is configured to perform testing operations. The testing circuit 130 includes a first test transistor T_AT_M2 and a second test transistor T_AT_Final. The first test transistor T_AT_M2 is coupled to the driving circuit 120 and the light emission control circuit 140. The second test transistor T_AT_Final is also coupled to the driving circuit 120 and the light emission control circuit 140. The first test transistor T_AT_M2 and the second test transistor T_AT_Final are controlled by a first test signal AT_M2 and a second test signal AT_Final, respectively. When the first test transistor T_AT_M2 is to be turned on, the first test signal AT_M2 is a DC signal. When the second test transistor T_AT_Final is to be turned on, the second test signal AT_Final is also a DC signal.

The light emission control circuit 140 is configured to control whether the μLED emits light based on a light emission control signal EM. The light emission control circuit 140 includes a first light-emission transistor T_AM_1. The first light-emission transistor T_AM_1 is coupled to the first and second test transistors T_AT_M2 and T_AT_Final of the testing circuit 130.

The bonding area 150 is configured for bonding to a μLED (not shown). The bonding area 150 includes pads 150_1 and 150_2.

During testing, the detailed structure of the testing circuit 130 is as follows. Upon completion of the fabrication of a first predetermined metal layer (for example, but not limited to, a third metal layer (M2)), a first test path P1 is formed. This first test path P1 passes through the first light-emission transistor T_AM_1 of the light emission control circuit 140, the first test transistor T_AT_M2 of the testing circuit 130 (where the first test signal AT_M2 is at a logic high level to turn on the first test transistor T_AT_M2, and at this time, the second test transistor T_AT_Final is turned off), and the driving circuit 120. This allows for the detection and repair of open defects that may exist prior to the fabrication of the first predetermined metal layer. In FIG. 1, a via V is used to pass through the first predetermined metal layer to the pad 150_2 in the bonding area 150.

In addition, upon completion of the fabrication of a second predetermined metal layer (for example, but not limited to, the final metal layer or the penultimate metal layer), a second test path P2 is formed. This second test path P2 passes through the first light-emission transistor T_AM_1 of the light emission control circuit 140, the second test transistor T_AT_Final of the testing circuit 130 (where the second test signal AT_Final is at a logic high level to turn on the second test transistor T_AT_Final, and at this time, the first test transistor T_AT_M2 is turned off), and the driving circuit 120. This configuration enables the detection of open defects that occur after the fabrication of the first predetermined metal layer (for example, but not limited to, an unopened via V).

Alternatively, as illustrated in FIG. 1, the test path P2 may be routed to the pad 150_2 in the bonding area 150, which may also be referred to as the μLED pad.

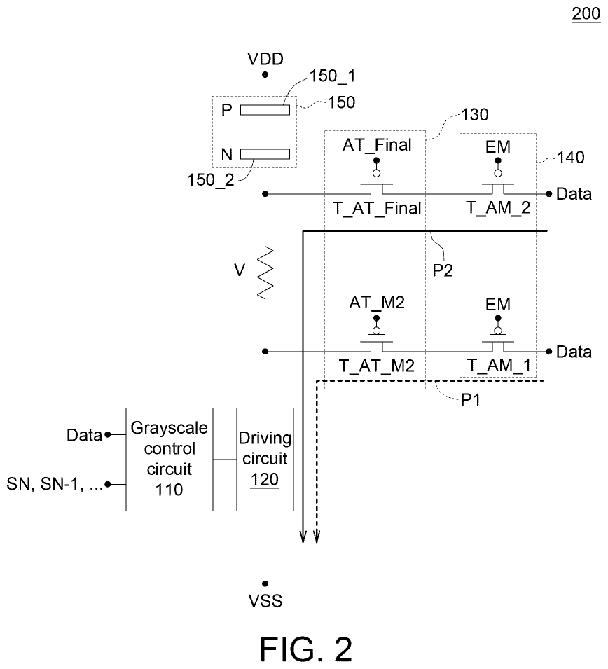

FIG. 2 illustrates a circuit diagram of a μLED driving circuit according to another embodiment of the present disclosure. In contrast to FIG. 1, the μLED driving circuit 200 shown in FIG. 2 includes a light emission control circuit 240 comprising a first light-emission transistor T_AM_1 and a second light-emission transistor T_AM_2. The first light-emission transistor T_AM_1 is coupled to the first test transistor T_AT_M2 of the testing circuit 130, while the second light-emission transistor T_AM_2 is coupled to the second test transistor T_AT_Final of the testing circuit 130.

In FIG. 2, the test details of the testing circuit 130 are as follows. Upon completion of the fabrication of a first predetermined metal layer (for example, but not limited to, a third metal layer (M2)), a first test path P1 is formed. This first test path P1 passes through the first light-emission transistor T_AM_1 of the light emission control circuit 140, the first test transistor T_AT_M2 of the testing circuit 130 (where the first test signal AT_M2 is at a logic high level to turn on the first test transistor T_AT_M2, while the second test transistor T_AT_Final is turned off), and the driving circuit 120. This enables testing for open defects that may exist prior to the fabrication of the first predetermined metal layer, thereby facilitating repair.

In FIG. 2, additionally, upon completion of the fabrication of a second predetermined metal layer (for example, but not limited to, the final metal layer or the penultimate metal layer), a second test path P2 is formed. This second test path P2 passes through the second light-emission transistor T_AM_2 of the light emission control circuit 140, the second test transistor T_AT_Final of the testing circuit 130 (where the second test signal AT_Final is at a logic high level to turn on the second test transistor T_AT_Final, while the first test transistor T_AT_M2 is turned off), and the driving circuit 120. This enables detection of open defects that arise after the fabrication of the first predetermined metal layer (for example, but not limited to, an unopened via V).

Alternatively, as shown in FIG. 2, the test path P2 may be routed to the pad 150_2 in the bonding area 150, which may also be referred to as a μLED pad.

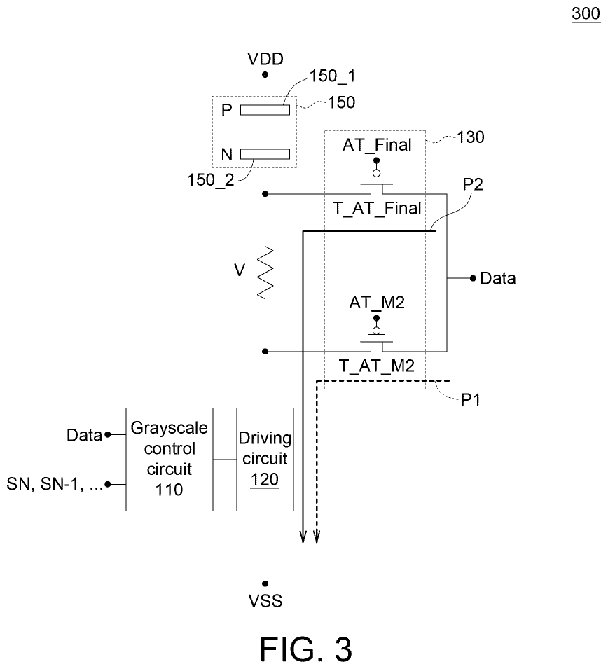

FIG. 3 illustrates a circuit diagram of a μLED driving circuit according to another embodiment of the present disclosure. Unlike FIG. 1, the μLED driving circuit 300 in FIG. 3 does not include a light emission control circuit. Both the first light-emission transistor T_AM_1 and the second light-emission transistor T_AM_2 receive a data signal Data.

In FIG. 3, the test details of the testing circuit 130 are as follows. Upon completion of the fabrication of a first predetermined metal layer (for example, but not limited to, a third metal layer (M2)), a first test path P1 is formed. This first test path P1 passes through the first test transistor T_AT_M2 of the testing circuit 130 (where the first test signal AT_M2 is at a logic high level to turn on the first test transistor T_AT_M2, while the second test transistor T_AT_Final is turned off), and the driving circuit 120. This allows for testing of open defects that may exist prior to the fabrication of the first predetermined metal layer, thereby facilitating repair.

In FIG. 3, additionally, upon completion of the fabrication of a second predetermined metal layer (for example, but not limited to, the final metal layer or the penultimate metal layer), a second test path P2 is formed. This second test path P2 passes through the second test transistor T_AT_Final of the testing circuit 130 (where the second test signal AT_Final is at a logic high level to turn on the second test transistor T_AT_Final, while the first test transistor T_AT_M2 is turned off), and the driving circuit 120. This enables detection of open defects that occur only after the fabrication of the first predetermined metal layer (for example, but not limited to, an unopened via V).

Alternatively, in FIG. 3, the test path P2 may be routed to the pad 150_2 in the bonding area 150 (also referred to as the μLED pad).

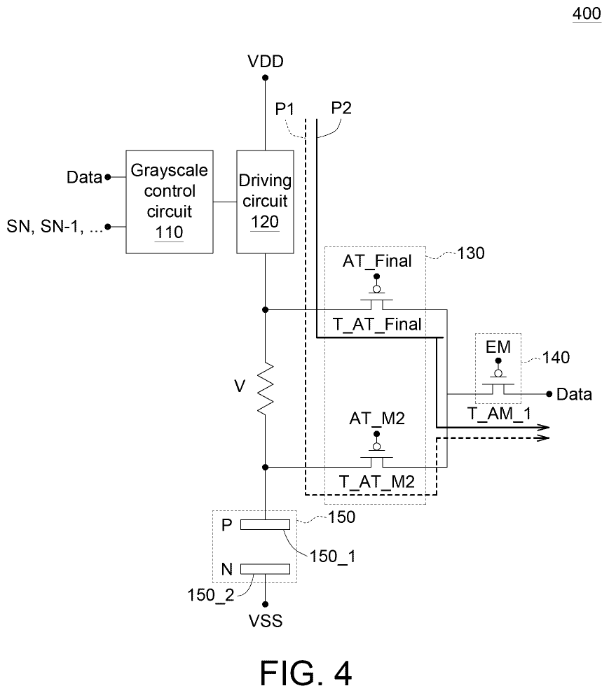

FIG. 4 illustrates a circuit diagram of a μLED driving circuit according to another embodiment of the present disclosure. The circuit diagram in FIG. 4 is similar to that in FIG. 1. However, the difference lies in the power connection configuration: in the μLED driving circuit 100 of FIG. 1, the driving circuit 120 is coupled to the reference voltage source VSS, and the μLED is coupled to the reference voltage source VDD. In contrast, in the μLED driving circuit 400 of FIG. 4, the driving circuit 120 is coupled to the reference voltage source VDD, and the μLED is coupled to the reference voltage source VSS.

In FIG. 4, the test details of the testing circuit 130 are as follows. Upon completion of the fabrication of a first predetermined metal layer (for example, but not limited to, a third metal layer (M2)), a first test path P1 is formed. This first test path P1 passes through the first test transistor T_AT_M2 of the testing circuit 130 (where the first test signal AT_M2 is at a logic high level to turn on the first test transistor T_AT_M2, while the second test transistor T_AT_Final is turned off), and the driving circuit 120. This allows for testing of open defects that may exist prior to the fabrication of the first predetermined metal layer; thereby facilitating repair.

In FIG. 4, additionally, upon completion of the fabrication of a second predetermined metal layer (for example, but not limited to, the final metal layer or the penultimate metal layer), a second test path P2 is formed. This second test path P2 passes through the first light-emission transistor T_AM_1 of the light emission control circuit 140, the second test transistor T_AT_Final of the testing circuit 130 (where the second test signal AT_Final is at a logic high level to turn on the second test transistor T_AT_Final, while the first test transistor T_AT_M2 is turned off), and the driving circuit 120. This enables detection of open defects that arise only after the fabrication of the first predetermined metal layer (for example, but not limited to, an unopened via V).

Alternatively, in FIG. 4, the test path P2 may be routed to the pad 150_2 in the bonding area 150 (also referred to as the μLED pad).

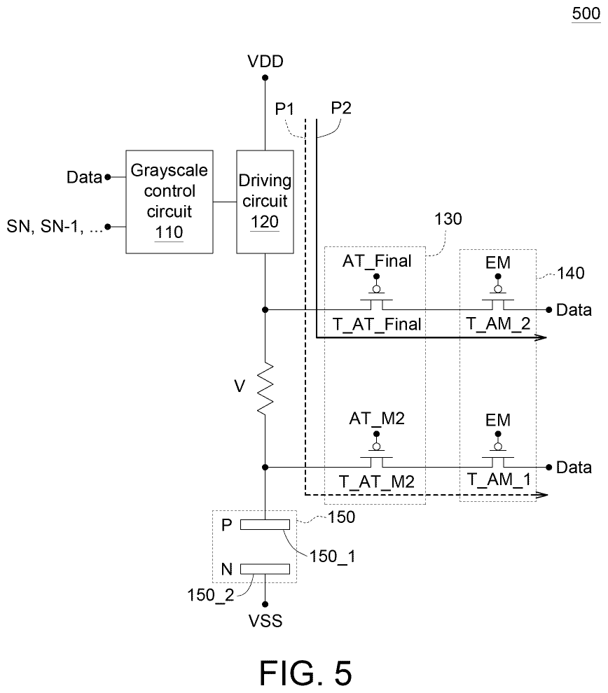

FIG. 5 illustrates a circuit diagram of a μLED driving circuit according to another embodiment of the present disclosure. The circuit diagram in FIG. 5 is similar to that in FIG. 2. However, the difference lies in the power connection configuration: in the μLED driving circuit 200 of FIG. 2, the driving circuit 120 is coupled to the reference voltage source VSS, and the μLED is coupled to the reference voltage source VDD. In contrast, in the μLED driving circuit 500 of FIG. 5, the driving circuit 120 is coupled to the reference voltage source VDD, and the μLED is coupled to the reference voltage source VSS.

In FIG. 5, the test details of the testing circuit 130 are as follows. Upon completion of the fabrication of a first predetermined metal layer (for example, but not limited to, a third metal layer (M2)), a first test path P1 is formed. This first test path P1 passes through the first light-emission transistor T_AM_1 of the light-emission control circuit 140, the first test transistor T_AT_M2 of the testing circuit 130 (where the first test signal AT_M2 is at a logic high level to turn on the first test transistor T_AT_M2, while the second test transistor T_AT_Final is turned off), and the driving circuit 120. This allows for the detection and repair of open defects that may exist prior to the fabrication of the first predetermined metal layer.

In FIG. 5, additionally, upon completion of the fabrication of a second predetermined metal layer (for example, but not limited to, the final metal layer or the penultimate metal layer), a second test path P2 is formed. This second test path P2 passes through the second light-emission transistor T_AM_2 of the light-emission control circuit 140, the second test transistor T_AT_Final of the testing circuit 130 (where the second test signal AT_Final is at a logic high level to turn on the second test transistor T_AT_Final, while the first test transistor T_AT_M2 is turned off), and the driving circuit 120. This allows for the detection of open defects that occur only after the fabrication of the first predetermined metal layer (for example, but not limited to, an unopened via V).

Alternatively, in FIG. 5, the test path P2 may be routed to the pad 150_2 in the bonding area 150 (also referred to as the μLED pad).

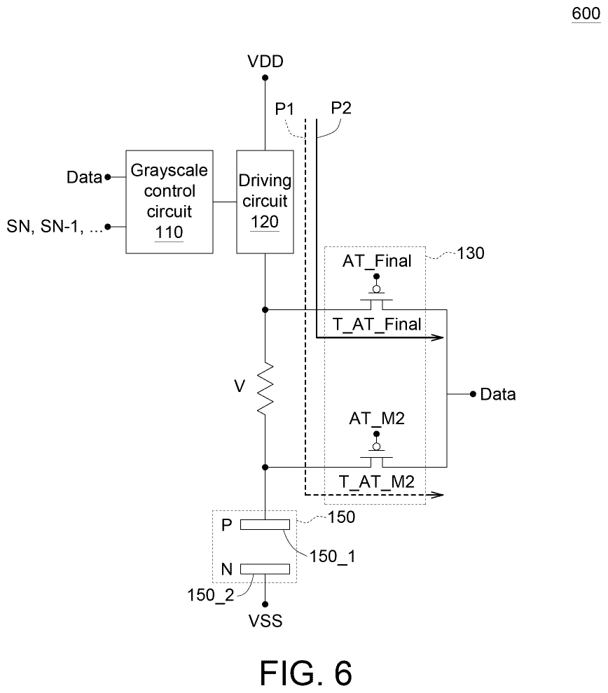

FIG. 6 illustrates a circuit diagram of a μLED driving circuit according to another embodiment of the present disclosure. The circuit diagram in FIG. 6 is similar to that in FIG. 3. However, the difference lies in the power connection configuration: in the μLED driving circuit 300 of FIG. 3, the driving circuit 120 is coupled to the reference voltage source VSS, and the μLED is coupled to the reference voltage source VDD. In contrast, in the μLED driving circuit 600 of FIG. 6, the driving circuit 120 is coupled to the reference voltage source VDD, and the μLED is coupled to the reference voltage source VSS.

In FIG. 6, the test details of the testing circuit 130 are as follows. Upon completion of the fabrication of a first predetermined metal layer (for example, but not limited to, a third metal layer (M2)), a first test path P1 is formed. This first test path P1 passes through the first test transistor T_AT_M2 of the testing circuit 130 (where the first test signal AT_M2 is at a logic high level to turn on the first test transistor T_AT_M2, while the second test transistor T_AT_Final is turned off) and the driving circuit 120. This allows for the detection and repair of open defects that may exist prior to the fabrication of the first predetermined metal layer.

In FIG. 6, additionally, upon completion of the fabrication of a second predetermined metal layer (for example, but not limited to, the final metal layer or the penultimate metal layer), a second test path P2 is formed. This second test path P2 passes through the second test transistor T_AT_Final of the testing circuit 130 (where the second test signal AT_Final is at a logic high level to turn on the second test transistor T_AT_Final, while the first test transistor T_AT_M2 is turned off) and the driving circuit 120. This allows for the detection of open defects that occur only after the fabrication of the first predetermined metal layer (for example, but not limited to, an unopened via V).

Alternatively, in FIG. 6, the test path P2 may be routed to the pad 150_2 in the bonding area 150 (also referred to as the μLED pad).

In one embodiment of the present disclosure, the architectures of the grayscale control circuit 110 and the driving circuit 120 are not particularly limited. However, to facilitate understanding of the present embodiment, examples of the grayscale control circuit 110 and the driving circuit 120 architectures will be provided below, although the disclosure is not limited thereto.

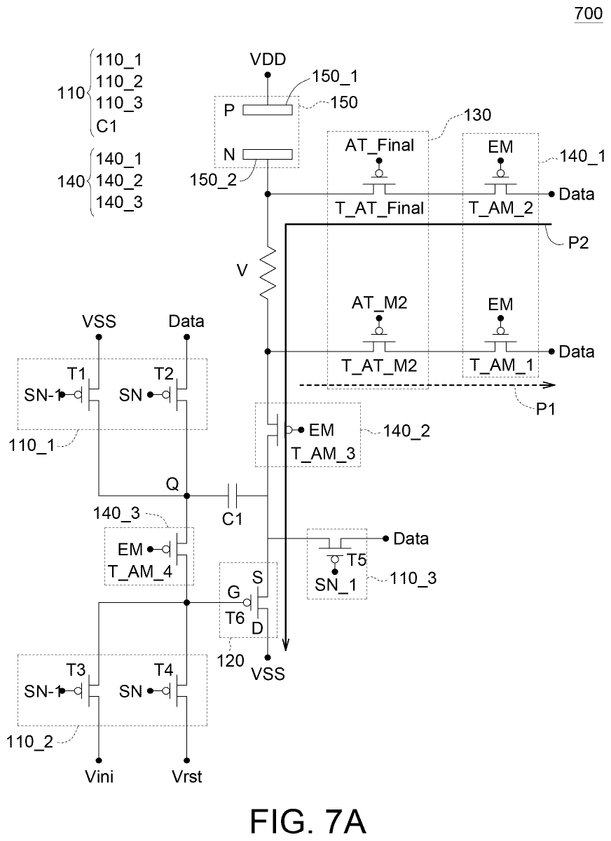

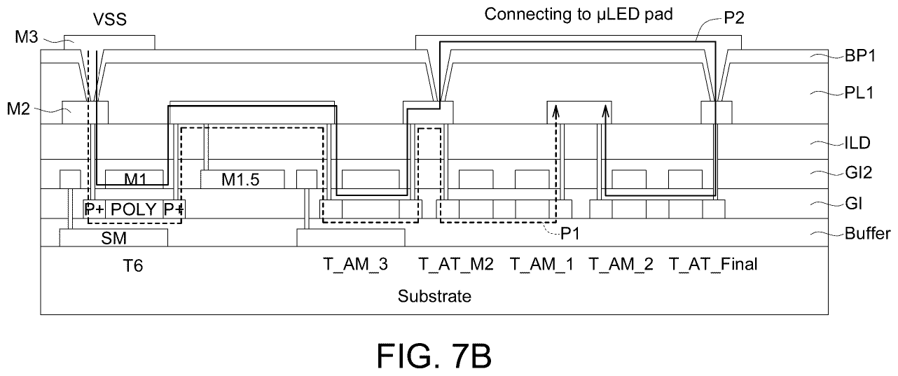

FIG. 7A illustrates a circuit diagram of a μLED driving circuit according to an embodiment of the present disclosure. FIG. 7B shows a partial cross-sectional view of the μLED driving circuit depicted in FIG. 7A. The μLED driving circuit 700 includes: a grayscale control circuit 110, a driving circuit 120, a testing circuit 130, a light-emitting control circuit 140, and a bonding area 150. The grayscale control circuit 110 comprises multiple grayscale sub-circuits 110_1 to 110_3 and a capacitor C1. The light-emitting control circuit 140 comprises multiple light-emitting sub-circuits 140_1 to 140_3. The bonding area 150 is used for bonding to a μLED. Additionally, the bonding area 150 includes pads 150_1 and 150_2.

The grayscale sub-circuit 110_1 includes transistors T1 and T2. The three terminals of transistor T1 are coupled to the reference voltage source VSS, a scan control signal SN-1, and a node Q. The three terminals of transistor T2 are coupled to a data signal (Data), a scan control signal SN, and node Q.

The grayscale sub-circuit 110_2 includes transistors T3 and T4. The three terminals of transistor T3 are coupled to an initial voltage Vini, a scan control signal SN-1, and the driving circuit 120. The three terminals of transistor T4 are coupled to a reset voltage Vrst, a scan control signal SN, and transistor T6 in the driving circuit 120.

The grayscale sub-circuit 110_3 includes transistor T5. The three terminals of transistor T5 are coupled to the initial voltage Vini, the scan control signal SN-1, and transistor T6 in the driving circuit 120.

The two terminals of capacitor C1 are coupled to node Q and the driving circuit 120.

The driving circuit 120 includes transistor T6. The three terminals of transistor T6 are coupled to the reference voltage source VSS, transistors T3 and T4 of the grayscale sub-circuit 110_2, and transistor T_AM_3 of the light-emitting sub-circuit 140_2.

The testing circuit 130 includes transistors T_AT_M2 and T_AT_Final. The three terminals of transistor T_AT_M2 are coupled to transistor T_AM_1, the first test signal AT_M2, and transistor T_AM_3. The three terminals of transistor T_AT_Final are coupled to transistor T_AM_2, the second test signal AT_Final, and transistor T_AM_3.

The light-emitting sub-circuit 140_1 includes transistors T_AM_1 and T_AM_2. The three terminals of transistor T_AM_1 are coupled to the data signal (Data), a light-emitting signal EM, and transistor T_AT_M2 of the testing circuit 130. The three terminals of transistor T_AM_2 are coupled to the data signal (Data), the light-emitting signal EM, and transistor T_AT_Final of the testing circuit 130.

The light-emitting sub-circuit 140_2 includes transistor T_AM_3. The three terminals of transistor T_AM_3 are coupled to transistor T6 in the driving circuit 120, the light-emitting signal EM, and the bonding area 150. The bonding area 150 is used for bonding to the μLED.

The light-emitting sub-circuit 140_3 includes transistor T_AM_4. The three terminals of transistor T_AM_4 are coupled to transistor T4, the light-emitting signal EM, and node Q.

The details of the grayscale control circuit 110, the driving circuit 120, the light-emitting control circuit 140, and the bonding area 150 are omitted here.

During testing, the details of the testing circuit 130 are as follows. When the fabrication of a first predetermined metal layer (e.g., but not limited to, the third metal layer (M2)) is completed, a first test path P1 is formed. This first test path P1 passes through transistor T_AM_1 of the light-emitting control circuit 140, transistor T_AT_M2 of the testing circuit 130 (the first test signal AT_M2 is at a logic high level to turn on transistor T_AT_M2, while transistor T_AT_Final is turned off), transistor T_AM_3 of the light-emitting control circuit 140, and transistor T6 of the driving circuit 120. This allows for testing of open-circuit defects that exist before the first predetermined metal layer is fabricated, which facilitates repair.

In addition, when the fabrication of a second predetermined metal layer (e.g., but not limited to, the final metal layer or the second-to-last metal layer) is completed, a second test path P2 is formed. This second test path P2 passes through transistor T_AM_2 of the light-emitting control circuit 140, transistor T_AT_Final of the testing circuit 130 (the second test signal AT_Final is at a logic high level to turn on transistor T_AT_Final, while transistor T_AT_M2 is turned off), transistor T_AM_3 of the light-emitting control circuit 140, and transistor T6 of the driving circuit 120. This enables detection of open-circuit defects that occur only after the first predetermined metal layer has been fabricated (e.g., but not limited to, via hole V not formed).

It can also be said that, in FIG. 7A, the detection path P2 is routed to pad 150_2 of the bonding area 150 (also referred to as a μLED pad).

FIG. 7B shows the signal paths of the first test path P1 and the second test path P2.

From the above, it can be understood that, in one embodiment of the present disclosure, when the fabrication of a first predetermined metal layer (e.g., but not limited to, the third metal layer (M2)) is completed, a first test path P1 is formed. This first test path P1 passes through the light-emitting control circuit 140 (which is an optional element), the testing circuit 130, and the driving circuit 120, thereby enabling the detection and repair of open-circuit defects existing prior to the fabrication of the first predetermined metal layer. Furthermore, when the fabrication of a second predetermined metal layer (e.g., but not limited to, the final metal layer or the second-to-last metal layer) is completed, a second test path P2 is formed. This second test path P2 also passes through the light-emitting control circuit 140 (optional element), the testing circuit 130, and the driving circuit 120, thereby enabling the detection of open-circuit defects that arise only after the fabrication of the first predetermined metal layer. This allows for more effective testing of defects in the μLED driving circuit.

While many specific details have been described in this case, these should not be construed as limitations to the scope of the claimed invention, but rather as descriptions of the characteristics of specific embodiments. Certain characteristics described in the context of a single embodiment may also be implemented in combination in a single embodiment. Conversely, various characteristics described in the context of a single embodiment may be implemented individually or in any suitable sub-combination in multiple embodiments. Moreover, although the characteristics may initially be described as functioning in certain combinations, or even initially illustrated as such, in some cases one or more characteristics may be deleted from the combination, and the described combination may be directed to a sub-combination or a variation of a sub-combination. Similarly, although operations are depicted in the illustrations as occurring in a particular order, this should not be understood as requiring that such operations be performed in the specific order shown or in sequential order, or that all depicted operations must be performed to achieve the desired result.

Although the above-described embodiments disclose some examples and implementations, changes, modifications, and enhancements can be made to the described examples and implementations and other implementations based on the disclosed content.

In summary, although the present invention has been disclosed above with embodiments, it is not intended to limit the present invention. Those skilled in the art to which this invention pertains can make various changes and refinements without departing from the spirit and scope of the invention. Therefore, the scope of protection of the present invention should be defined by the appended claims.

What is claimed is:

1. A method for testing a micro light-emitting diode (μLED) driving circuit, comprising:
in response to completion of fabrication of a first predetermined metal layer, forming a first test path, the first test path passing through a driving circuit and a first test transistor of a test circuit, for testing at least one first defect existing prior to fabrication of the first predetermined metal layer; and
in response to completion of fabrication of a second predetermined metal layer, forming a second test path, the second test path passing through the driving circuit and a second test transistor of the test circuit, for detecting at least one second defect occurring after the fabrication of the first predetermined metal layer.

2. The method of claim 1, wherein the first predetermined metal layer is a third metal layer, and the second predetermined metal layer is a final metal layer or a second-to-last metal layer.

3. The method of claim 1, wherein:
in response to the formation of the first test path, a first test signal is applied to turn on the first test transistor and to turn off the second test transistor, the first test signal being a direct current signal; and
in response to the formation of the second test path, a second test signal is applied to turn on the second test transistor and to turn off the first test transistor, the second test signal being a direct current signal.

4. The method of claim 1, wherein the first test path and the second test path further pass through a light-emitting control transistor of a light-emitting control circuit.

5. The method of claim 1, wherein:
the first test path further passes through a first light-emitting transistor of a light-emitting control circuit; and
the second test path further passes through a second light-emitting transistor of the light-emitting control circuit.

6. A micro light-emitting diode (μLED) driving circuit, comprising:
a grayscale control circuit;
a driving circuit coupled to the grayscale control circuit;
a test circuit coupled to the driving circuit, the test circuit including a first test transistor and a second test transistor;
wherein
in response to completion of fabrication of a first predetermined metal layer, forming a first test path, the first test path passing through the driving circuit and the first test transistor of the test circuit, for testing at least one first defect existing prior to fabrication of the first predetermined metal layer; and
in response to completion of fabrication of a second predetermined metal layer, forming a second test path, the second test path passing through the driving circuit and the second test transistor of the test circuit, for detecting at least one second defect occurring after the fabrication of the first predetermined metal layer.

7. The micro light-emitting diode (μLED) driving circuit of claim 6, wherein the first predetermined metal layer is a third metal layer, and the second predetermined metal layer is a final metal layer or a second-to-last metal layer.

8. The micro light-emitting diode (μLED) driving circuit of claim 6, wherein:
in response to the formation of the first test path, a first test signal is applied to turn on the first test transistor and to turn off the second test transistor, the first test signal being a direct current signal; and
in response to the formation of the second test path, a second test signal is applied to turn on the second test transistor and to turn off the first test transistor, the second test signal being a direct current signal.

9. The micro light-emitting diode (μLED) driving circuit of claim 6, wherein the first test path and the second test path further pass through a light-emitting control transistor of a light-emitting control circuit.

10. The micro light-emitting diode (μLED) driving circuit of claim 6, wherein:
the first test path further passes through a first light-emitting transistor of a light-emitting control circuit; and
the second test path further passes through a second light-emitting transistor of the light-emitting control circuit.
